(19) United States
(12) Patent Application Publication
(10) Pub. No.: US 2012/0180809 A1
(43) Pub. Date: Jul. 19, 2012

(54) EASY DENTAL FLOSSING DEVICE AND FLOSSING METHOD

(76) Inventor: Mingwu Bai, (US)

(21) Appl. No.: 13/007,669

(22) Filed: Jan. 17, 2011

(51) Int. Cl. A61C 15/04

(52) U.S. Cl. 132/327

(57) ABSTRACT

A dental flossing device comprises a handle, two holder elements, a hook, a slider, and a spring. A strand of floss with several tied knots on two open ends generates closed loop of floss. A closed loop of floss is positioned in slots of two holder elements. A reciprocal moving slider connects to a hook, the hook pull the floss against a pressed spring in the handle. When depress the slider, the floss is pulled tightly by the stressed spring. The tightly stretched floss can clean the teeth.

### RELATED APPLICATIONS

No.

### RELATED PATENTS

| | | | |
|---|---|---|---|
| 11/690,679 | September | Frank | Pub. No.: |
| | 2007 | Conte et al | US 2007/0209953 A1 |
| 12/231,26 | March | Robert | Pub. No.: |
| | 2010 | Frazer Mason | US 2010/0051052 A1 |
| 4,034,770 | July | Francis J. | |
| | 1977 | Trecker | |
| 5,483,982 | January | Clayton | |
| | 1996 | Bennett at al | |
| 5,819,769 | October | Gregorio | |
| | 1998 | Gutierrez | |
| 12/217,879 | January | Chung-Shan | Pub. No.: |
| | 2010 | Shen et al | US 2010/0006120 A1 |
| 12/484,398 | February | Gilbert | Pub. No.: |
| | 2010 | Baughman | 2010/0037912 A1 |

### FIELD OF THE INVENTION

This invention pertains to dental flossing tool to clean teeth, and more particularly to a dental flossing device having spring and hook to pull tightly a strand of floss in closed loop.

### BACKGROUND OF THE INVENTION

People needs to clean teeth everyday using a variety of tools including dental floss for dental health and for avoiding cavities along with other oral problems with the teeth and gums. The regular use of dental floss as suggested by dentists and hygienists can clean the food remnants in between the teeth.

Some people hold the floss in their hands, force a strand of floss stretching between two fingers, and put their fingers into their mouth and force the floss to clean in between teeth. This method is not convenient to clean everywhere between the adjacent teeth using two fingers, because that it is a little bit difficult to hold the floss between two fingers in the limited space in the mouse, and that it is difficult to touch everywhere in the mouse using two fingers for holding floss.

Some people use different type of holders for holding dental floss and clean the teeth. Some holders are composed of a strand of floss which is stressed between plastic sticks. These types of floss are permanently attached to the holder, they are discarded after use, hence such products waste too much resource, and also it needs large container for storage. Other types of floss holders are of permanent type, people just need to replace floss after use. These kinds of holders are complex and expensive, and they are not convenient to use for repositioning or replacing floss after use.

Some people hold a dental flossing tool in one hand and with the other hand grasps the free end of the floss strand. Floss is too slippery to grasp, and finger feels very pain during flossing if people try to wind the free end of the floss about his finger in order to obtain a grip on it.

The present invention provides a dental floss holder and method to overcome the aforesaid shortcomings.

### SUMMARY OF THE INVENTION

A dental flossing method comprises generating a closed loop of floss with several tied knots on the two open ends of a strand of floss with suitable length, and the closed loop of floss is tightly set in a dental flossing device. A dental flossing device comprises a handle portion and hook portion. The handle portion comprises a slider container, two holder elements for positioning and holding a strand of floss. The hook portion comprises a slider, a hook, and a spring. The hook can impart force on floss and pull floss tightly by a positioning slider which is pressed by a spring in the handle container. The slider can slide smoothly in the inner of handle. Push slider can release dental floss from the hook. The floss can change after use.

### BRIEF DESCRIPTION OF THE DRAWINGS

FIG. 1 is a perspective view of a flossing device in accordance with the presented embodiment of the present invention;

FIG. 2 is an exploded view of the flossing device;

FIG. 3 is a cross-sectional view of handle of the flossing device;

FIG. 4 is a perspective view of two holder elements of the flossing device;

FIG. 5 is a perspective view of slider with hook of the flossing device;

FIG. 6 is a perspective front view of flossing device with a closed loop of floss installed;

FIG. 7 is a perspective right view of flossing device with a closed loop of floss installed;

FIG. 8 is a perspective view of threaded handle of the flossing device;

FIG. 9 is a perspective view of pad with screw;

FIG. 10 is a cross-sectional view of floss storage unit;

### DESCRIPTION OF PREFERRED EMBODIMENTS

Although the present invention can be made in many different forms, the presently preferred embodiments are described in this disclosure and shown in the attached drawings. This disclosure exemplifies the principles of the present invention and does not limit the broad aspects of the invention only to the illustrated embodiments.

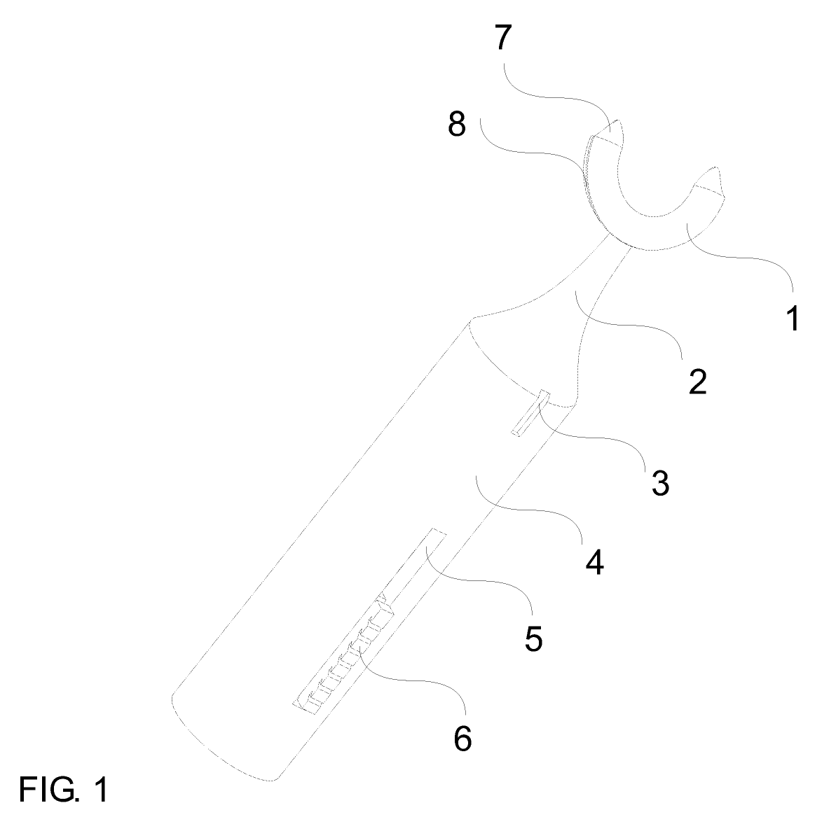

For the purpose of illustration in FIG. 1, a dental floss device in accordance with the present invention comprises two holder elements 1, handler 2, guide notch 3, cylinder holder 4, moving guidance window 5, and hook 6.

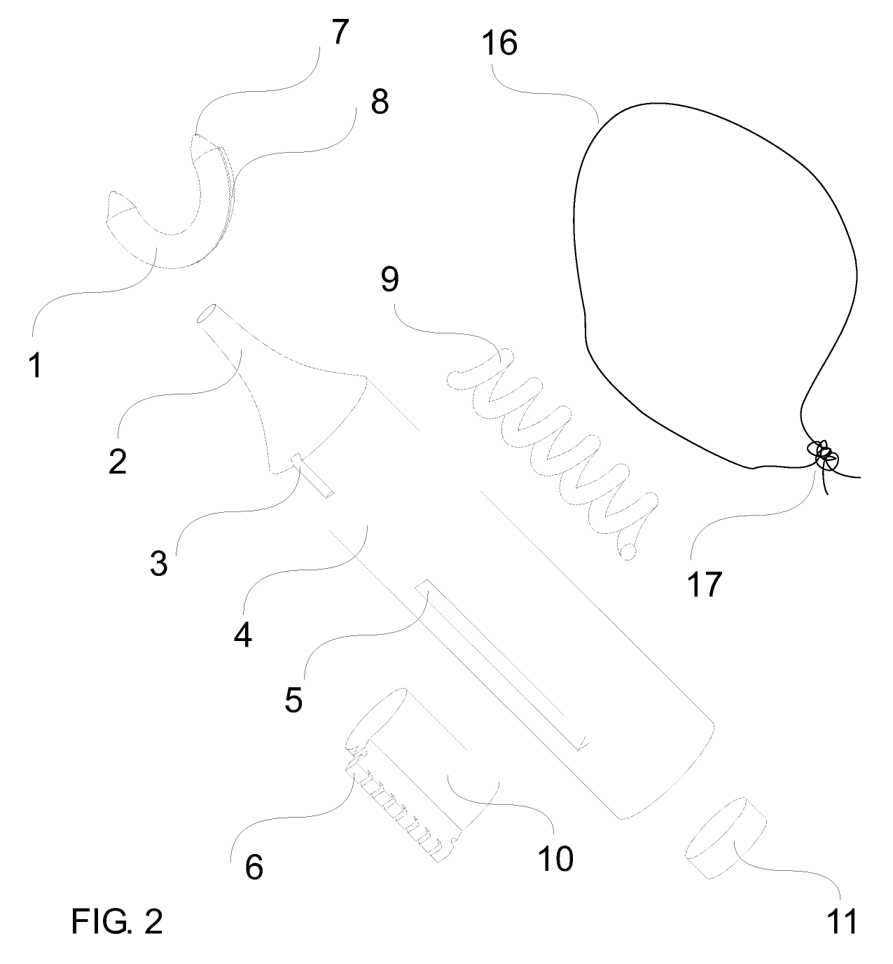

As shown in exploded view in FIG. 2 for the purpose of illustration, the dental floss holder in accordance with the present invention also comprises spring 9, positioning slider 10, pad 11, a strand of floss 16, and tied multiple knots 17 on the floss.

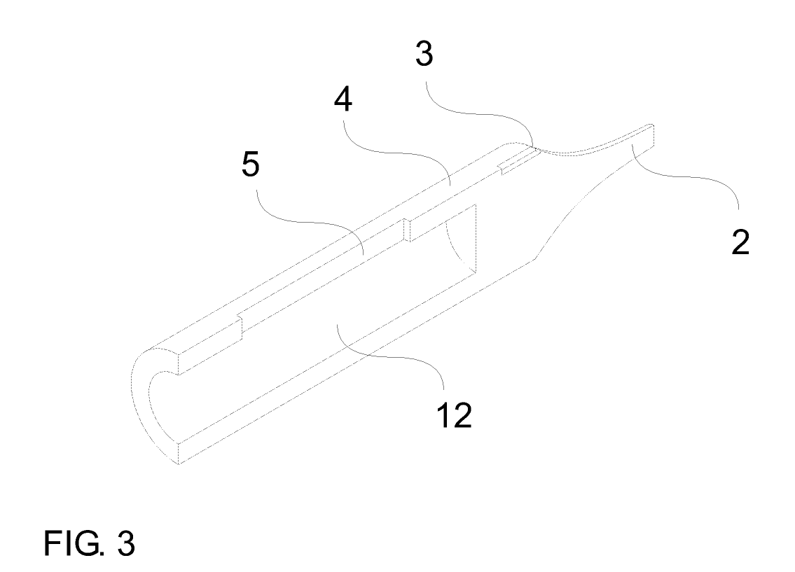

For the purpose of illustration in a cross-sectional view of cylinder holder 4 in FIG. 3, the inside of cylinder holder 4 is has an empty cylinder container 12. It contains spring 9 and positioning slider 10.

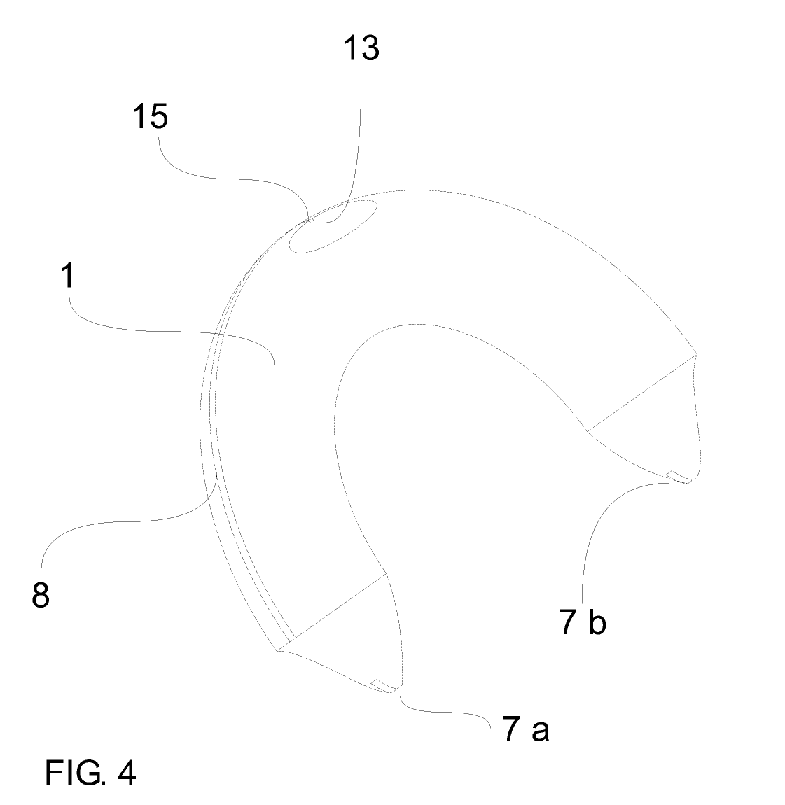

For the purpose of illustration in FIG. 4, two holder elements 1 have two guide slots 7a and 7b, shallow guiding grooves 8, and positioning notch 15. Two holder elements with guide slots 7a and 7b are spaced apart a distance. The flat portion 13 is connected to handler 2.

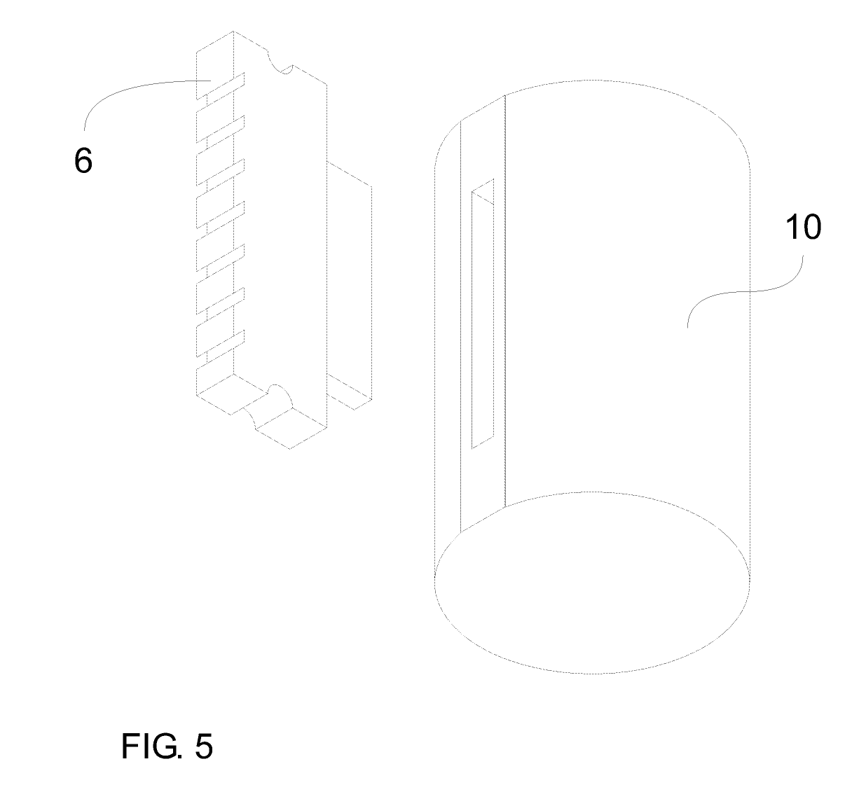

For the purpose of illustration in FIG. 5, the hook 6 inserts into the trench of positioning slider 10 and they are physically fixed together after assembling. The diameter of the positioning slider 10 is a little smaller than the diameter of slider container 12. The positioning slider 10 can move smoothly in the slider container 12 only in the direction of axis of slider container 12 under the guidance of the moving guidance window 5. The hook 6 has multi slots, because the perimeter of the close loop floss with tied knots may change and we can select a suitable slot to hook the closed loop of floss 16.

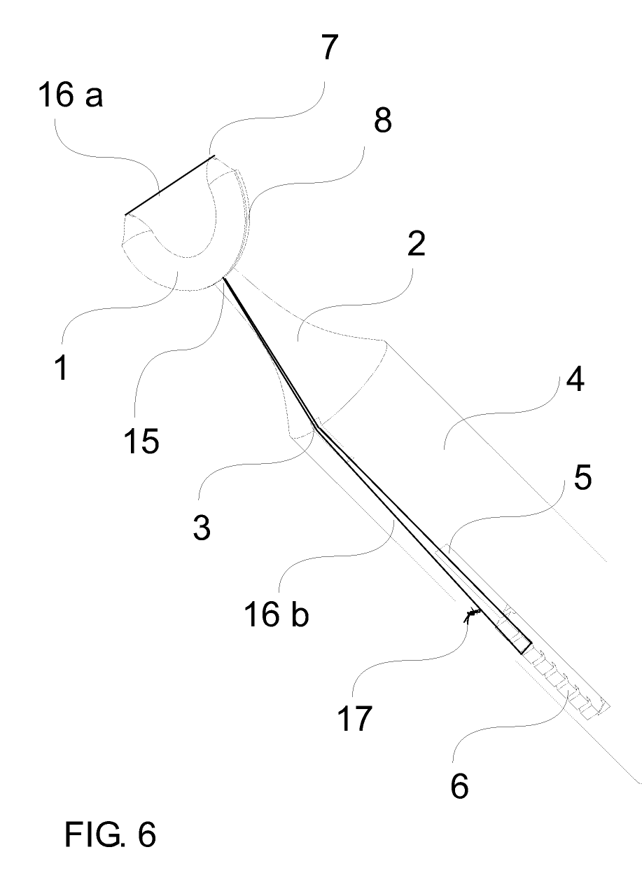

For the purpose of illustration in FIG. 6, during assembling, spring 9 (not shown in FIG. 6) is at first put into slider container 12, then positioning slider 10 slides into slider container 12, and after that the hook 6 inserts into the trench of positioning slider 10 from the moving guidance window 5, and finally end pad 11 is situated at the bottom of cylinder holder 4.

In practice, a strand of floss with suitable length is cut and obtained from commercial floss box. The dental flossing method comprises generation of a closed loop of floss, and installation the closed loop of floss in the flossing device. At first, we put two open ends of a strand of floss together and tie knots to generate closed loop of floss. Because the dental floss is very slippery and difficult to grip, the closed loop of floss with one knot or two knots can be easily broken and split up even with small force by two fingers. However, experiments show that closed loop of floss by tying 3 to 5 knots on two open ends of a strand of floss is strong enough to withstand large force if we try to pull apart the loop by two fingers or other tools with large force.

For the purpose of illustration in FIG. 6 in front view, we put the closed loop of floss 16a along the guide slots 7 of two holder elements 1, guiding grooves 8, and then floss converges at positioning notch 15, and at guide notch 3. We then push the hook 6 (and hence positioning slider 10) toward two holder elements 1 with force against the inside spring 9, and finally hook the closed loop of floss 16b by hook 6. The tied knots 17 can be anywhere near the hook 6 or cylinder holder 4. When release the pushing force, the spring 9 will pull tightly the floss. Then the stressed floss between two holder elements 1 can be used to floss the teeth in any direction and any position in the mouse conveniently. During flossing, one can push or pull the positioning slider 10 upward or downward with a little force so that the floss can be more stressed or less stressed. The working section of the floss can be changed by changing the position of tied knots 17. This can be done by push the slider toward the holder elements 1 to release the floss 16 from the stressed hook 6. Therefore, most part of floss can be used for flossing during one use, and it saves flossing cost.

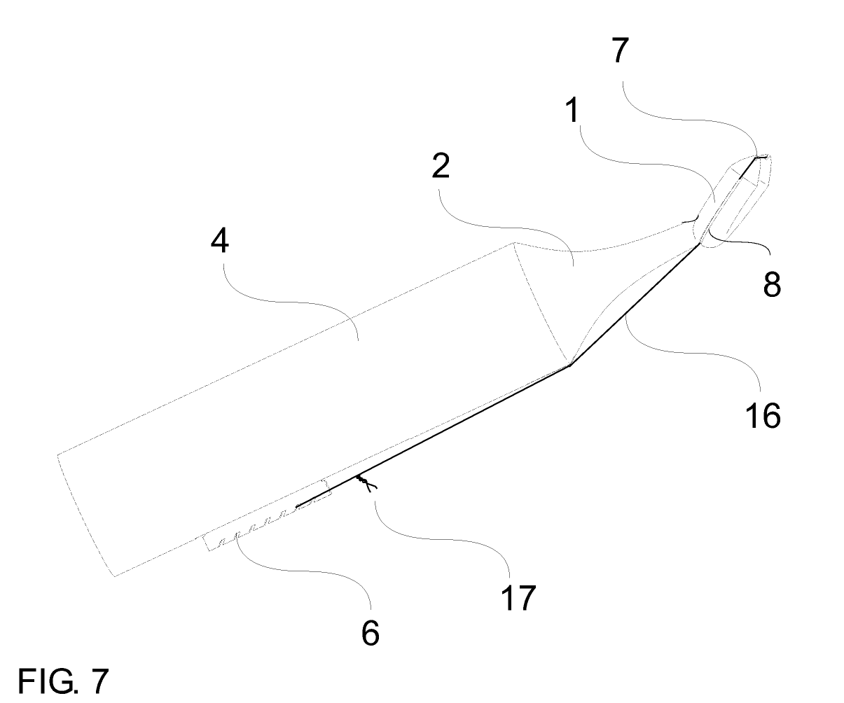

For the purpose of illustration in FIG. 7 in right view, it shows the close loop of floss 16 and tied knots 17. The floss is pulled tightly due to compressed spring.

The closed loop of floss can be removed and discarded after flossing by pushing the slider toward the direction of two holder elements 1 to release the floss for next flossing.

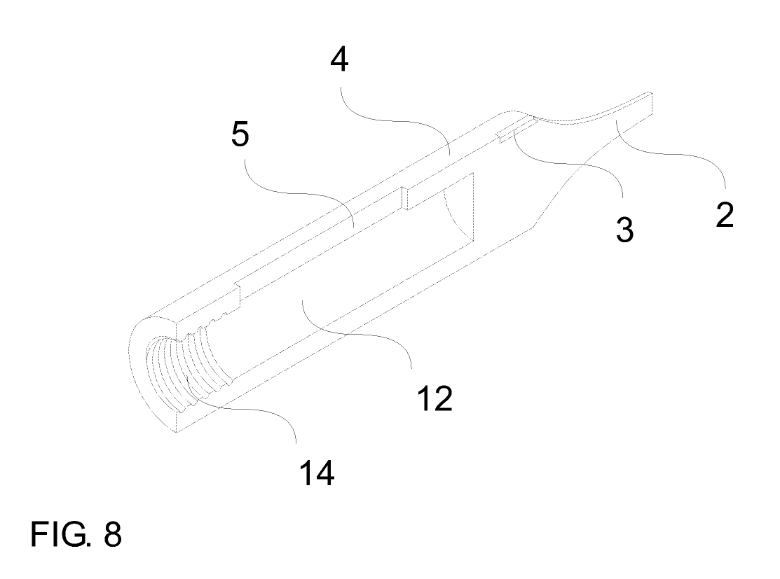

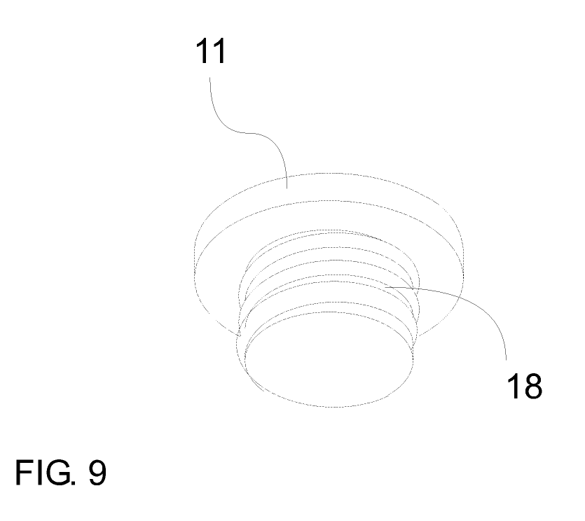

It is to be understood that the dental flossing holder and dental flossing method shown in FIG. 1 described above is merely illustrative of bodies, and there are many methods to pull the closed loop of floss tightly. For example, for the purpose of illustration in FIG. 8 and in FIG. 9, spring 9 can be situated and physically connected between positioning slider 10 and end pad 11. After the closed loop of floss is hooked, we can rotate end pad 11 to separate the screw 18 from the screwed grooves 14, the hook 6 will move toward the direction of end pad 11, and the spring 9 will be stressed, so the stressed spring will pull the closed loop of floss tightly.

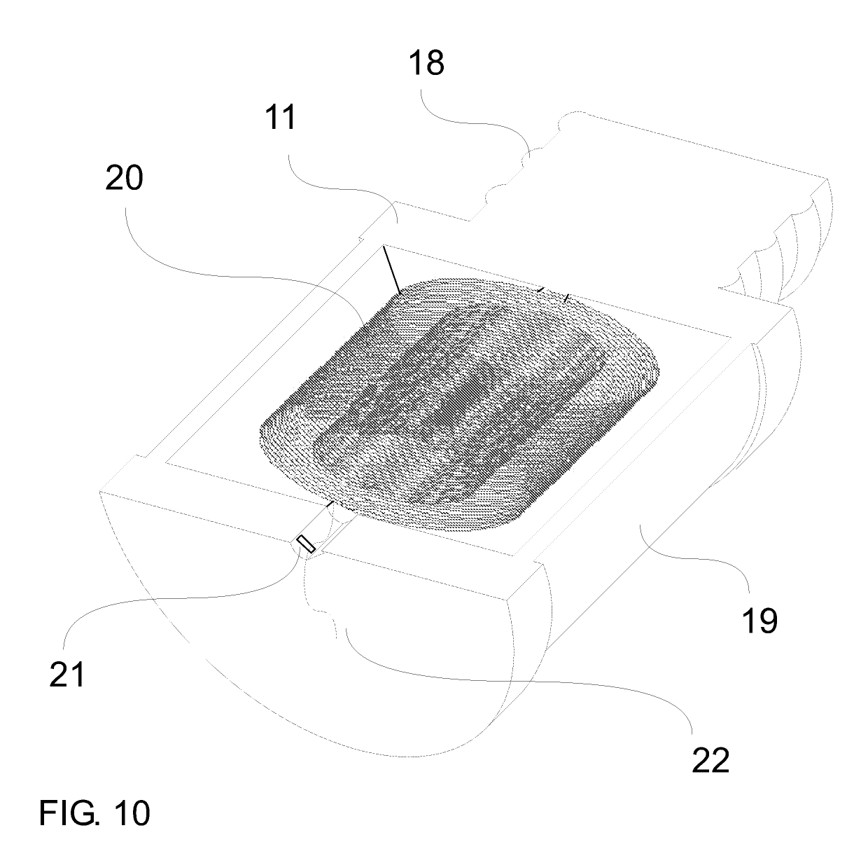

In an alternative embodiment, for the purpose of illustration in FIG. 10 in sectional view, the end pad 11 may connect to a storage unit 19. A spindle in storage unit 19 can carry very long floss 20 for use in couple of week even several months. For each use, just pull the open end of floss 22 from storage unit 19 and obtain a strand of floss by cutting it with a tiny knife edge 21.

For easy manufacturing, low cost, and light weight, except for the spring, most of the dental flossing device is preferably made of injection-molded ABS plastic, but could also be any other suitable plastic material such as polycarbonate, polystyrene, polypropylene, or PEEK.

According to the provisions of the patent statues, we have explained the principle, preferred construction of the invention and have illustrated and described what we now consider to represent its best embodiments. However, it should be understood that within the scope of the claims and the foregoing description, the invention may be practiced otherwise than specifically illustrated and described.

It is to be understood that the dental flossing device and dental flossing method shown in FIG. 1 described above is merely illustrative of bodies which can be embodies in the holder construction of the invention and the invention is in no way limited to exact construction and shape.

What is claimed is:

1. A dental flossing method by generating a closed loop of floss by tying multiple knots on the two open ends of a strand of floss, and said closed loop of floss is pulled tightly by a dental flossing device;

2. A dental flossing device comprising a handle having two holder elements, a slider container, a slider for imparting force to floss, a spring and a hook, said two holder elements have guide slots at their open ends, said slider container is hollow, cylinder like and having a longitudinal axis, said slider is guided for reciprocal movement along said longitudinal axis, said hook is physically fixed onto one side of said slider, said hook comprising means of reciprocal movement relative to said handler when said spring is pressed or depressed, said hook pull tightly said floss away from said two holder elements when said spring is depressed after pushing said hook (and hence said spring) to some distance toward said two holder elements and forming a spring means, said hook is guided by a guidance window in said slider container.
